(19) United States
(12) Patent Application Publication
(10) Pub. No.: US 2018/0373804 A1
(43) Pub. Date: Dec. 27, 2018

(54) METHOD AND DEVICE FOR LOADING INFORMATION STREAM PAGE

(71) Applicant: Guangzhou Shenma Mobile Information Technology Co. Ltd., Guangzhou (CN)

(72) Inventor: Zhaoxiang ZHANG, Guangzhou (CN)

(21) Appl. No.: 16/016,494

(22) Filed: Jun. 22, 2018

(30) Foreign Application Priority Data
Jun. 23, 2017 (CN) 201710485981.7

(51) Int. Cl. G06F 17/30; G06F 3/0488; G06F 3/0485

(52) U.S. Cl. CPC G06F 17/30905; G06F 3/0485; G06F 3/0488

(57) ABSTRACT

The present invention discloses a method and device for loading an information stream page. The method comprises: displaying the information stream page on a touch screen of a mobile terminal, wherein the information stream page comprises a plurality of partitioned information title blocks adjacent to one another; detecting a gesture operation of browsing the information stream page; determining a current browsing position according to the detected gesture operation; and preloading a new information stream before the current browsing position reaches the bottom of a current information stream page. Therefore, based on the gesture operation and the current browsing position, the new information stream is preloaded on the currently displayed information stream page to improve the smoothness of scrolling motion, such that a user can browse more information content smoothly and users' browsing experience is substantially improved.

### CROSS-REFERENCED APPLICATION

The present application claims priority under the Paris Convention to Chinese Patent Application No.: 201710485981.7 filed on Jun. 23, 2017, and titled Method and Device for Loading Information Stream Page, the content of which is incorporated herein by reference.

### TECHNICAL FIELD

The present invention relates to page interaction, and in particular to a method and device for loading an information stream page.

### BACKGROUND

With the continuous popularization and development of mobile terminals, it gradually becomes a trend to use various applications (for example, browser applications, news applications, etc.) installed on a mobile terminal such as a smart phone to access the Internet. Meanwhile, the consumer demand for information streams is also increasing day by day.

In commonly available applications used for internet browsing, for example, various common browser applications and news applications, as generally shown in FIG. 1, an information stream is formed of a plurality of partitioned information title blocks 1 adjacent to one another. When browsing, a user can move the information stream by swiping vertically. When an interesting information title block is found, the user can click on the information title block to read the detailed content. The information stream is often in a state of being constantly updated, and certain operations can be carried out by the user to load the information stream to read new information title blocks. In one embodiment, the user can load new information content, i.e., the new information title blocks, via an upward swiping operation or by a clicking operation of a refresh button 2 when browsing the bottom of the page.

Such an information loading manner can meet the browsing expectation of the user to some extent. However, in the case of a poor network connection or loading mistakes, the new page content may not be refreshed in a timely manner. As a result, it is difficult for the user to browse the information stream page uninterrupted, and the user's browsing experience deteriorates.

In view of this, there is a need for a new method of loading the information stream to ensure that the user can browse the information stream page without interruption.

### SUMMARY

In order to solve at least one of the above problems, the present disclosure provides a method and device for loading an information stream page. The method can preload a new information stream before the user reaches the end of a page based on a gesture operation and a current browsing position of the user, to improve the smoothness of the browsing process and fully improve the browsing experience.

According to an aspect of the present disclosure, a method for loading an information stream page on a mobile terminal is disclosed. The method comprises: displaying the information stream page on a touch screen of the mobile terminal, wherein the information stream page comprises a plurality of partitioned information title blocks adjacent to one another; detecting a gesture operation of browsing the information stream page; determining a current browsing position according to the detected gesture operation; and preloading a new information stream before the current browsing position reaches the bottom of the current information stream page. Herein in the present disclosure, the “bottom” of an information stream page refers to the end of the content available on the page.

Therefore, by monitoring the user's gesture operation and the current browsing position, preloading can be performed before the current browsing position reaches the bottom of the page, so that the new information stream can be loaded in time without the user being aware, thereby ensuring that the user has a smooth browsing experience.

The gesture operation may be a gesture of sliding a page upwards or downwards, and may also be other gestures that meet operation requirements.

Preloading of a new information stream before the current browsing position reaches the bottom of the current information stream page can be carried out in multiple ways. For example, the new information stream may be preloaded when the current browsing position reaches a first threshold of percentage of the current information stream page. The new information stream may also be preloaded when the current browsing position is away from the bottom of the current information stream page by the distance of a second threshold. Or the new information stream is preloaded when the current browsing position is away from the bottom of the current information stream page by only a third threshold number of information title blocks. One or more preloading mechanisms can be flexibly set according to an actual condition, thereby ensuring the user a smooth browsing experience.

Preferably, the time of preloading the new information stream may be related to the speed of the user's gesture operation. Therefore, the preloading flexibility and actual handling capacity can be further improved.

Usually, the new information stream may be displayed at the bottom of the current information stream page, while for some special information title blocks, for example, important breaking news or important promotion campaigns, etc., the preloaded new information stream may also be inserted into the current browsing position or at the top of the current browsing position, thereby obtaining a new current information stream page.

Hence, different preloading positions can be set for different information streams, to achieve optima configuration of the information streams.

If the new information stream fails to preload before the current browsing position reaches the bottom of the current information stream page, the new information stream can be loaded automatically or according to a refresh gesture when the current browsing position reaches the bottom of the current information stream page. The refresh gesture may be an upward pull after the bottom of the information stream page is reached, but may also be a refresh gesture of clicking a refresh button or the like.

According to another aspect of the present invention, there is further provided a device for loading an information stream page on a mobile terminal. The device comprises: a page displaying unit, configured for displaying the information stream page on a touch screen of the mobile terminal, wherein the information stream page comprises a plurality of partitioned information title blocks adjacent to one another; a gesture detecting unit, configured for detecting a gesture operation of browsing the information stream page; a position judging unit, configured for judging a current browsing position according to the detected gesture operation; and a preloading unit, configured for preloading a new information stream before the current browsing position reaches the bottom of the current information stream page. Herein in the present disclosure, the term “unit” may refer to a processing circuit, a CPU, a microprocessor, or other computing devices known to a person skilled in the art that are programmed to perform a task or function.

Similarly, the gesture operation detected by the gesture detecting unit may be a gesture of sliding a page upwards or downwards or other gestures suitable for actual operations.

Preferably, the preloading unit may preload a new information stream when one of the following conditions is met: when the current browsing position reaches a first threshold of percentage of the current information stream page; when the current browsing position is away from the bottom of the current information stream page by a second threshold of distance; or when the current browsing position is away from the bottom of the current information stream page by only a third threshold of number of information title blocks.

Preferably, the device may further comprise a speed calculating unit. The speed calculating unit may calculate the speed of the gesture operation. The preloading unit determines the time of preloading the new information stream according to the speed of the gesture operation.

Preferably, the device may also comprise a page refreshing unit. The page refreshing unit may be configured to position the preloaded new information stream at the bottom of the current information stream page, to obtain a new current information stream page.

The page refreshing unit may also be configured to insert the preloaded new information stream at the current browsing position or at the top of the preloaded new information stream, to obtain the new current information stream page.

If the new information stream fails to be preloaded before the current browsing position reaches the bottom of the current information stream page, then the page refreshing unit may be further configured to load the new information stream automatically or according to a refresh gesture when the current browsing position reaches the bottom of the current information stream page. The refresh gesture detected by the gesture detecting unit is an upward pull after the bottom of the information stream page is reached.

According to yet another aspect of the present invention, there is also provided an electronic device, comprising: a touch screen; a processor; and a memory. Executable codes are stored in the memory. When the executable codes are executed by the processor, the processor is caused to execute any above method for loading an information stream page.

According to still a further aspect of the present invention, there is also provided a non-transient machine-readable memory medium. Executable codes are stored in the non-transient machine-readable memory medium. When the executable codes are executed by the processor of an electronic device, the processor is caused to execute any above method for loading an information stream page.

With the solution for loading the information stream page according to the present invention, it is possible to preload the new information stream based on the gesture operation and the current browsing position of the user before the user reaches the bottom of the information stream page in order that the user may browse smoothly, thereby improving the browsing experience of the user. Besides, with flexible setting of the preloading mechanism, it is possible to accommodate various cases in practical application scenarios, and thus substantially improve the applicability and flexibility of the preloading solution.

### BRIEF DESCRIPTION OF THE DRAWINGS

The above and other objectives, characteristics and advantages of the present disclosure will be apparent from detailed description on exemplary embodiments of the present disclosure in combination with the accompanying drawings. In the exemplary embodiments of the present disclosure, the same reference signs generally represent the same parts.

FIG. 1 shows an existing example of interactive operations with an information stream page.

FIG. 2 is a schematic diagram of an environment where a user implements an embodiment of the present disclosure.

FIG. 3 shows a schematic flowchart of a method for loading an information stream page according to an embodiment of the present disclosure.

FIG. 4 shows an application example according to the present disclosure.

FIG. 5 shows a schematic block diagram of a system for loading an information stream page according to an embodiment of the present disclosure.

FIG. 6 shows a schematic block diagram of an electronic device according to an embodiment of the present disclosure.

### DETAILED DESCRIPTION

Preferred embodiments according to the present disclosure are described in more detail with reference to the accompanying drawings. Although preferred embodiments of the present disclosure are shown in the accompanying drawings, it should be understood that the present disclosure can be implemented in various forms rather than being limited by the embodiments described here. On the contrary, these embodiments are provided for making the present disclosure more thorough and complete, and for fully conveying the scope of the present disclosure to those skilled in the art.

With the gradual maturity of means for users to browse information streams on a mobile terminal, the improvement of the user's browsing experience is a problem that must be considered by respective content providers when providing rich content for the users to browse.

In view of this, the present invention provides a solution for loading an information stream page. Based on the detected gesture operation and the current browsing position of the user, before reaching the bottom of an information stream page, a new information stream is preloaded to ensure the user a smooth browsing experience, thereby improving user experience. In addition, with the specific definition of a preloading mechanism, the flexibility of preloading the information stream can also be improved, thereby providing a new commercialization path for a browsing service supplier, and benefits for both the user and the operator.

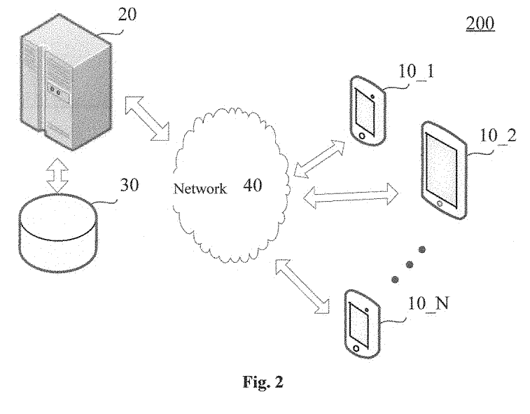

The solution of loading the information stream page provided by the embodiment of the present disclosure may be applied to an environment as shown in FIG. 2. FIG. 2 is a schematic diagram of the environment 200 wherein an embodiment of the present disclosure is implemented. In one embodiment, a terminal device 10 in the environment 200 may realize, via a network 40, information transceiving with a server 20. The server 20 can obtain the required content by accessing a database 30.

The network 40 may be the network for information transmission in a broad sense, and may comprise one or more communication networks, such as a wireless communication network, the Internet, a private area network, a local area network, a metropolitan area network, a wide area network, a cellular data network, etc. In one embodiment, the network 40 may also comprise a satellite network, where a GPS signal of the terminal device 10 is transmitted to the server 20.

It should be noted that, whether additional modules are added to or removed from the reference sign 200, the underlying concept of the exemplary embodiment of the present invention will not be changed. In addition, although the figure shows a two-way arrow between the database 30 and the server 20 for the purpose of explanation, those skilled in the art could understand that the above data transmission may also be implemented via the network 400.

The terminal device 10 is any proper electronic device that may be used for network access, preferably a portable mobile electronic device, including but not limited to a smart phone, a tablet computer or other portable client terminal. The server 20 is any network-accessible server capable of providing information required by interactive services.

Although the figure shows a plurality of terminal devices 10-1 . . . N and a single server 20 and a database 30, and one or part of these mobile terminals will be described in the following description (for example, the mobile terminal 10-1), those skilled in the art should understand that the above 1 . . . N mobile terminals are intended to represent multiple mobile terminals existing in real networks. The single server 20 and the database 30 which are shown are intended to indicate that the operation of the technical solution according to the present disclosure involve the server and the database. The mobile terminals with specific numbers and the single server and the single database are described in detail to facilitate explanation, rather than imply a limitation to the types, positions, etc. of the mobile terminals and the server.

The terminal device 10 may monitor the current information stream page and acquire a new information stream from the server 20. The new information stream is inserted to the proper position relative to the current information stream page at a proper time to obtain a new information stream page. At this point, the server 20 and each terminal device 10 may be regarded as a system for loading an information stream page that implements the embodiments of the present disclosure.

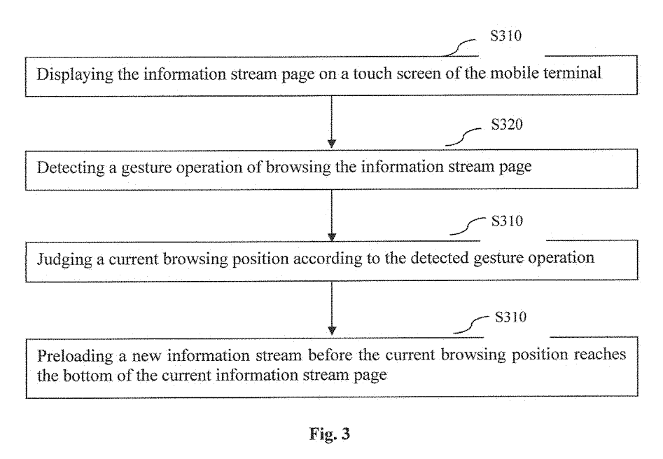

Any terminal 10 acquiring the information stream from the server 20 may execute the method for loading an information stream page as shown in FIG. 3. FIG. 3 shows a schematic flowchart of the method for loading an information stream page according to an embodiment of the present invention. The information stream page mentioned herein may comprise a plurality of information title blocks, and may also comprise detailed information content, for example, texts, images, tables, audio, videos or any combination thereof.

The method for loading an information stream page as shown in FIG. 3 begins from step S310. In step S310, the information stream page is displayed on a touch screen of the mobile terminal. The information stream page may comprise a plurality of partitioned information title blocks adjacent to one another.

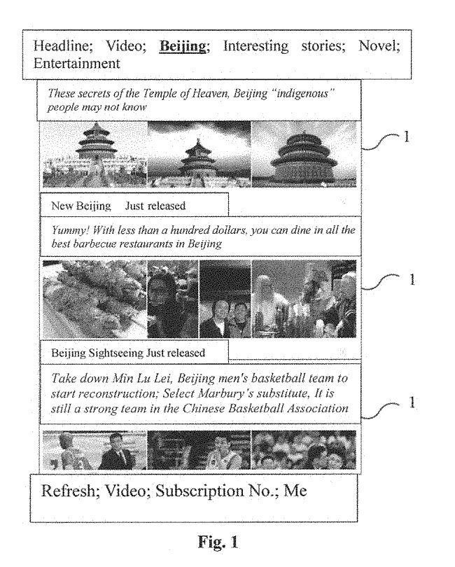

The information title blocks for example may be the title blocks of articles, news, advertisements, videos, etc., as shown in FIG. 1, and may also be sub-channel title blocks, image-only blocks, etc., as long as the terminal user can distinguish that they direct to content different from surrounding title blocks. In other words, the information title blocks herein do not necessarily refer to blocks that have text titles, but may also refer to blocks which can direct to specific content via clicking on the block content, and such directing can generally be recognized by the terminal user. In addition, the term “partitioned” does not imply that all title blocks are rectangular. The information title blocks may also have other shapes as long as the user can enter the content represented by the information title blocks by the operation thereupon, for example clicking. The information stream page may also comprise only detailed information content, for example, information content formed from article title lines arranged in sequence.

In step S320, a gesture operation of browsing the information stream page is detected.

The gesture operation here may be a daily gesture for browsing, for example, a sliding gesture which moves a page upwards or downwards, but may also be other proper gestures, which are not limited herein. In addition, when the information stream page is displayed on a non-portable terminal device such as a laptop or a desktop computer, the gesture operation may be the detected action of a page scroll bar.

Generally speaking, the gesture operation may be periodically detected, or may also be detected in response to a user operation. When a gesture operation is detected, not only is the action of a gesture operation detected, but also other relevant gesture information, for example the speed and the frequency of the gesture operation, can also be detected correlatively.

In step S330, a current browsing position is judged according to the detected gesture operation.

The current browsing position refers to the current displayed position of the information stream page being browsed by the user. When the user swipes the touch screen, the position of the information stream page corresponding to the portion of the touch screen touched by the hand of the user, or the position displayed by the information stream page after the sliding in response to the gesture operation, can be detected. Preferably, the current displayed position can be represented by the threshold percentage of the current information page, or a distance from the bottom of the page and the like.

It should be understood that the sequence of the step S320 and the step S330 is not fixed. The step S320 and the step S330 may be performed simultaneously in specific practice.

However, in step S340, the new information stream is preloaded before the current browsing position reaches the bottom of the current information stream page. Here, the new information stream may refer to a set of new information title blocks updated on a server between loadings.

Preloading the new information stream before the current browsing position reaches the bottom of the current information stream page can increase the loading efficiency of the information stream and improve the smoothness of the user's browsing experience enabling the user to smoothly browse the content on the information stream page. Here, the preloading of the information stream is performed after the user starts to browse the information stream page and before the user reaches the bottom of the page, and is preferably performed only once at a selected time point, so as to avoid extra burden on data communication caused by frequent preloading.

The time of preloading the new information stream may be set to be determined by the current browsing position. The preloading time may be the time when the current browsing position reaches a first threshold of percentage of the current information stream page, for example, the time when the middle position (½ or fifty percent) of a current page is read. The distance from the current browsing position to the bottom of the page may also be represented by a pixel number. The new information stream is preloaded when the current browsing position is away from the bottom of the current information stream page by a second threshold of distance. Alternatively, the new information stream is preloaded when the current browsing position is away from the bottom of the current information stream page by a third threshold of number of information title blocks, for example, when it is only three un-displayed title blocks away from the bottom of the page.

The determination of the preloading time can meet any of the above conditions or a combination thereof. For example, the first threshold of percentage is set to be 50%, and if the loading fails at this point, then the new information stream is again automatically preloaded when the distance to the bottom of the page is the third threshold of number of information title blocks (for example, 3). If the automatic preloading fails, the new information stream is automatically loaded when the bottom of the information stream page is reached.

The preloading time may further be adjusted according to an actual condition. For example, the time of preloading the new information stream may be related to the speed of the gesture operation.

When the gesture operation is detected in Step S320, the speed of the gesture operation may be detected correlatively. The time of preloading the new information stream is determined based on the speed of the gesture operation. The speed of the gesture operation may be the gesture speed when the user executes the gesture operation once, and may also be a frequency of the gesture operation in predetermined time. In a preferred embodiment, a predetermined speed may also be set. When the detected speed of the gesture operation is higher than the predetermined speed, the gesture operation of the user is regarded as a fast action. When the detected speed of the gesture operation is lower than the predetermined speed, the gesture operation of the user is regarded as a slow action. The preloading time set for the fast action is earlier than the preloading time determined by the current browsing position. The preloading time set for the slow action is later than the preloading time determined by the current browsing position.

The time of preloading the new information stream may also be related to other information, for example, a current network speed. The network may be monitored in real time. If the network is in good condition and the network speed is fast, the time required for loading the new information stream may be shorter, and then the preloading time can be set relatively late. If the network is in poor condition and the network speed is slow, the time required for loading the new information stream may be longer, and then the preloading time can be set relatively early.

The preloading time may be any appropriate time set as desired, which is not limited by the present disclosure. Therefore, with reasonable configuration, the preloading time of the new information stream is set more reasonably, and sufficient loading time is provided for preloading the information stream.

The new information stream may be arranged in any proper position relative to the current information stream page. Generally speaking, the preloaded new information stream may be arranged at the bottom of the current information stream page. For some special information title blocks, for example, important breaking news or important promotion campaigns, etc., the preloaded new information stream may also be inserted at the current browsing position or at the top.

The loading position of the new information stream is usually set in detail according to the detailed condition of the new information stream. Taking the news as an example, a title block of common news may be inserted at the bottom of the current information stream page, and a title block of important news may be inserted at the current browsing position or at the top of the current information stream page. Real-time news updates or news topics indicated as interesting to the user, may also be inserted at the current browsing position, so that the user may be informed about the latest news or so that the information stream page can be tailored to the user.

If the new information stream fails to be preloaded before the current browsing position reaches the bottom of the current information stream page, the new information stream may be loaded automatically or according to a refresh gesture when the current browsing position reaches the bottom of the current information stream page. Preferably, a loading priority may be set, and the new information stream can be automatically loaded based on priority. If automatic loading fails, then the new information stream is loaded according to a refresh gesture of the user.

The refresh gesture may be an upward swipe after the bottom of the information stream page is reached, or may also be a clicking operation of a refresh button or other proper refresh gestures. The loaded new information stream may be arranged at the bottom of the page, at the top of the page, or in other proper loading positions.

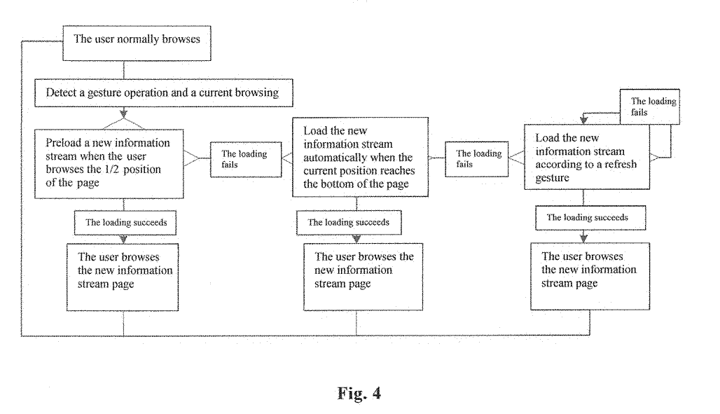

FIG. 4 shows an embodiment according to the present disclosure. The preloading time is set to be the time when the currently browsed page reaches the 50% (½) position of the current information stream page.

The gesture operation and the current browsing position of the user are detected in real time when the user normally browses the information stream page, and a determination is made as to whether the current browsing position reaches the ½ position of the information stream page. When the ½ position is reached, the new information stream is inserted at the proper position of the current information stream page. The new information stream page for normal browsing is provided for the user in the case of successful loading. If the loading fails (for example, network errors or other loading errors occur), then it is possible that the new information stream is not preloaded for the moment.

When the bottom of the information stream page is reached, the new information stream is loaded automatically at the proper position of the page. The new information stream page for normal browsing is provided for the user in the case of successful loading. If automatic loading fails, then the new information stream is loaded according to the refresh gesture of the user to obtain a new information stream page for the user to browse normally. If the loading fails, then the refresh operation can be continuously executed until the loading is successful.

Therefore, with the preloading mechanism according to the present disclosure, the new information stream page can be loaded in the proper position of the information stream page at the appropriate time, thereby improving browsing smoothness user and substantially improving user experience.

So far, the method for loading an information stream page according to the invention has been explained in detail in combination with the accompanying drawings and the embodiments. The method for loading an information stream page according to the disclosure may be implemented by a device for loading an information stream page.

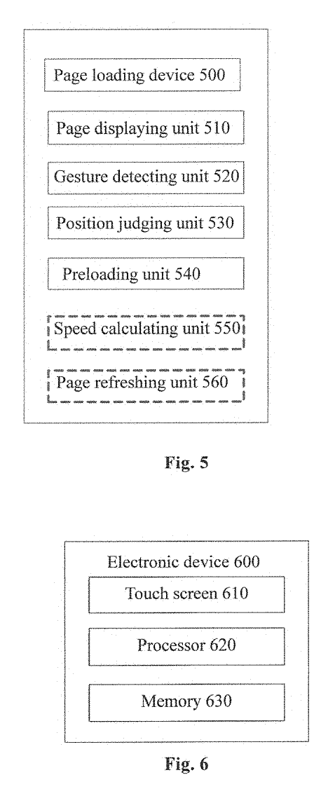

FIG. 5 shows a schematic block diagram of a device for loading an information stream page according to an embodiment of the present disclosure. The functional modules of a device 500 for loading a page may be implemented by hardware, software or a combination thereof, which realize the principles of the present disclosure. In some embodiments, the term “module” may refer to a processing circuit, a CPU, a microprocessor, or other computing devices known to a person skilled in the art that programmed to perform a task or function. It can be understood by those skilled in the art that the functional modules described in FIG. 5 may be combined or partitioned into sub-modules, thereby realizing the above principles of the disclosure. Therefore, the description herein can support any possible combination or partition or further definition on the functional modules described herein.

The device 500 for loading a page as shown in FIG. 5 can be configured to implement the method for loading an information stream page as shown in FIG. 3. The following text briefly describes the functional modules that may be possessed by the device 500 for loading a page, and the operations that can be executed by respective functional modules. The details involved can refer to the description above in combination with FIG. 3 and are not repeated here.

As shown in FIG. 5, the device 500 for loading a page according to the present disclosure may comprise a page displaying unit 510, a gesture detecting unit 520, a position judging unit 530 and a preloading unit 540.

The page displaying unit 510 may display the information stream page on a touch screen of the mobile terminal. The information stream page comprises a plurality of partitioned information title blocks adjacent to one another.

The gesture detecting unit 520 may detect a gesture operation of browsing the information stream page. The gesture operation may be a gesture of sliding a page upwards or downwards.

The position judging unit 530 may judge a current browsing position according to the detected gesture operation.

The preloading unit 540 may preload a new information stream before the current browsing position reaches the bottom of the current information stream page. Preferably, the preloading unit 540 may preload the new information stream when one of the following conditions is met: when the current browsing position reaches a first threshold of percentage of the current information stream page; when the current browsing position is away from the bottom of the current information stream page by a second threshold of distance; and when the current browsing position is away from the bottom of the current information stream page by only a third threshold of number of information title blocks.

Optionally, the device 500 for loading a page may further comprise a speed calculating unit 550. The speed calculating unit 550 may calculate the speed of the gesture operation. The preloading unit 540 may determine a time of preloading the new information stream according to the speed of the gesture operation.

Optionally, the device 500 for loading a page may further comprise a page refreshing unit 560. The page refreshing unit 560 may be configured to arrange the preloaded new information stream at the bottom of the current information stream page, to obtain a new current information stream page. The page refreshing unit 560 may be further configured to insert the preloaded new information stream at the current browsing position or at the top of the preloaded new information stream, to obtain a new current information stream page.

If the new information stream fails to preload before the current browsing position reaches the bottom of the current information stream page, then the page refreshing unit may be further configured to load the new information stream automatically or according to a refresh gesture when the current browsing position reaches the bottom of the current information stream page. The refresh gesture detected by the gesture detecting unit is an upward pull after the bottom of the information stream page is reached.

The method for loading an information stream page according to the present disclosure may be further implemented by an electronic device. FIG. 6 shows a schematic diagram block of an electronic device 600 according to an embodiment of the present disclosure. The electronic device 600 may be the terminal device 10 as shown in FIG. 2.

As shown in FIG. 6, the electronic device 600 according to the present invention may comprise a touch screen 610, a processor 620 and a memory 630. Executable codes may be stored on the memory 630. When the executable codes are executed by the processor, the processor 620 is caused to execute the method for loading an information stream page according to the present disclosure. Specific implementation may refer to related description of FIG. 3 as above, and is not repeated here.

The method for loading an information stream page according to the present disclosure has been described in detail with reference to the accompanying drawings herein. According to the present disclosure, based on the gesture operation and the current browsing position, before the current browsing position reaches the bottom of the current information stream page, the new information stream page is preloaded, thereby improving browsing smoothness and the user experience.

In addition, the method described by the present disclosure may also be implemented as a computer program or computer program product. The computer program or computer program product comprises computer program code instructions configured to execute the steps described in the above-disclosed methods.

Alternatively, the present invention may be implemented as a non-transient machine-readable memory medium (or computer-readable memory medium or machine-readable memory medium), where executable codes (or computer programs or computer instruction codes) are stored. When the executable codes (or the computer programs or the computer instruction codes) are executed by the processor of an electronic device (or a calculating device, a server, etc.), the processor executes the steps described in the above-disclosed methods.

Those skilled in the art would also understand that various exemplary logic blocks, modules, circuits, and algorithm steps described in combination with the disclosure herein can be implemented as electronic hardware, computer software or a combination of both.

The flowcharts and the block diagrams in the accompanying drawings display the infrastructures, functions and operations which may be realized by the system and the method according to the multiple embodiments of the present disclosure. At this point, each block in the flowcharts or the block diagrams may represent part of a module, a program segment or codes, and the part of the module, the program segment or the codes contains one or more executable instructions configured to realize specified logic functions. It should be noted that in some alternative implementations, the functions marked in the blocks may also occur in a sequence different from that marked in the accompanying drawings. For example, two consecutive blocks may be executed substantially in parallel or in the opposite sequence, depending on the functions involved. It is also noted that each block in the block diagrams and/or the flowcharts and the combination thereof can be realized by a hardware-based system specifically for executing specified functions or operations, by the combination of specific hardware and computer instructions.

Various embodiments of the present disclosure have been described. The above explanation is exemplary and not exhaustive, and is not limited to the disclosed respective embodiments. Various modifications and alterations may be apparent to those ordinarily skilled in the art without departing from the scope and spirit of the explained respective embodiments. The selection of the terms herein is intended to best explain the principles and the practical applications of each embodiment or the improvement thereof on the prior art, or allow other ordinarily skilled in the art to understand the respective embodiments disclosed herein.

1. A method for loading an information stream page on a mobile terminal, comprising:
displaying the information stream page on a touch screen of the mobile terminal, wherein the information stream page comprises a plurality of partitioned information title blocks adjacent to one another;
detecting a gesture operation of a user browsing the information stream page;
determining a current browsing position based on the detected gesture operation; and
preloading a new information stream before the current browsing position reaches the bottom of a current information stream page.

2. The method according to claim 1, wherein the gesture operation is a gesture of swiping a page upwards or downwards.

3. The method according to claim 1, wherein preloading a new information stream before the current browsing position reaches the bottom of a current information stream page comprises one of the followings:
preloading the new information stream when the current browsing position reaches a first threshold of percentage of the current information stream page;
preloading the new information stream when the current browsing position is away from the bottom of the current information stream page by a second threshold of distance; or
preloading the new information stream when the current browsing position is away from the bottom of the current information stream page by only a third threshold of number of information title blocks.

4. The method according to claim 3, wherein when the new information stream is preloaded depends on a speed of the gesture operation.

5. The method according to claim 1, further comprising: placing the preloaded new information stream at the bottom of the current information stream page, to obtain a new current information stream page.

6. The method according to claim 1, further comprising: inserting the preloaded information stream to the current browsing position or topping the preloaded new information stream, to obtain a new current information stream page.

7. The method according to claim 1, further comprising: if preloading the new information stream before the current browsing position reaches the bottom of the current information stream page fails, loading the new information stream automatically or according to a refresh gesture when the current browsing position reaches the bottom of the current information stream page.

8. The method according to claim 7, wherein the refresh gesture is an upward pull after the bottom of the information stream page is reached.

9. A system for loading an information stream page on a mobile terminal, comprising:
a page displaying device, configured for displaying the information stream page on a touch screen of the mobile terminal, wherein the information stream page comprises a plurality of partitioned information title blocks adjacent to one another;
a gesture detecting device, configured for detecting a gesture operation of browsing the information stream page;
a position determination device, configured for determining a current browsing position according to the detected gesture operation; and
a preloading device, configured for preloading a new information stream before the current browsing position reaches the bottom of the current information stream page.

10. The system according to claim 9, wherein the gesture operation detected by the gesture detecting device is a gesture of sliding a page upwards or downwards.

11. The system according to claim 9, wherein the preloading device preloads the new information stream when one of the following conditions is met:
when the current browsing position reaches a first threshold of percentage of the current information stream page;
when the current browsing position is away from the bottom of the current information stream page by a second threshold of distance; or
when the current browsing position is away from the bottom of the current information stream page by only a third threshold of number of information title blocks.

12. The system according to claim 11, further comprising a speed calculating device, wherein the speed calculating device calculates a speed of the gesture operation, and the preloading device determines a time for preloading the new information stream according to the speed of the gesture operation.

13. The system according to claim 9, further comprising: a page refreshing device, configured to place the preloaded new information stream at the bottom of the current information stream page to obtain a new current information stream page.

14. The system according to claim 13, wherein the page refreshing device is further configured to insert the preloaded new information stream at the current browsing position or at the top of the current information stream page to obtain the new current information stream page.

15. The system according to claim 13, wherein when the new information stream fails to preload before the current browsing position reaches the bottom of the current information stream page, the page refreshing device is further configured to load the new information stream automatically or according to a refresh gesture when the current browsing position reaches the bottom of the current information stream page.

16. The system according to claim 15, wherein the refresh gesture detected by the gesture detecting device is an upward pull after the bottom of the information stream page is reached.

17. An electronic device, comprising:
a touch screen;
a processor; and
a memory having executable codes stored thereon, wherein when the executable codes are executed by the processor, the processor is caused to execute the method according to claim 1.

18. A non-transient machine-readable memory medium having executable codes stored thereon, wherein when the executable codes are executed by a processor of an electronic device, the processor is caused to execute the method according to claim 1.
